(19) United States
(12) Patent Application Publication
(10) Pub. No.: US 2005/0003830 A1
(43) Pub. Date: Jan. 6, 2005

(54) Smart telephone call routing for wireless communication devices

(75) Inventor: David T. Campbell, Redmond, WA (US)

Correspondence Address: LEE & HAYES PLLC, 421 W RIVERSIDE AVENUE SUITE 500, SPOKANE, WA, 99201, US

(73) Assignee: MICROSOFT CORPORATION, REDMOND, WA (US)

(21) Appl. No.: 10/609,308

(22) Filed: Jun. 27, 2003

(51) Int. Cl. H04Q 7/20

(52) U.S. Cl. 455/456.1; 455/404.2; 455/414.1

(57) ABSTRACT

The present disclosure relates to calls to a particular communication service and carrier networks, based on location of a user. The user has a wireless communication wireless communication device that functions as a locator of the user, and indicates where the user may be in proximity to communication networks that provide communication services to the user. The various communication networks may include wireless networks with plain old telephone systems with access points that communicate with the wireless communication device. Particular networks may have devices that are enabled with wireless technology to communicate with the wireless communication device. Calls may be forwarded to the wireless communication device or other communication device of a determined network based on the desire of the user.

### TECHNICAL FIELD

The systems and methods described herein relate to routing calls to a communications carrier. More specifically, the systems and methods provide for wireless communication devices to determine location of a user, locate communication services accessible by the user, and instruct service providers to route calls for the user to a particular communication service.

### BACKGROUND

Well connected individuals may have several communication devices and associated communication services. Communication devices include wireless (i.e., cellular) telephones, plain old telephone service (POTS) telephones, and wireless personal digital assistants (PDA). In certain cases an individual that travels between different countries/regions may have particular communication services (i.e., cellular networks) for each country/region. Associated with each communication device is a “telephone number” used by others to contact the user of the communication device. Therefore, multiple telephone numbers may be associated with one individual that has multiple communication devices. Typically, different service providers are associated with each communication device. Different service providers may have different service rates depending on the type of communication services offered.

Although there may be some overlap in the type and quality of communication services that are provided by communication devices, particular communication devices provide unique communication services that are not offered by other communication devices. For example, all communications devices provide the ability to talk to other parties; however, a cellular phone frees a user from network (i.e., wired) constraints of typical POTS systems.

Communications services may also be distinguished from one another by the type of network infrastructure they use and their cost to operate. For example, a satellite telephone transmits and receives communications to and from a low earth orbit satellite at a frequency known as L-band. A cellular telephone transmits and receives communications from various base stations and cellular antennas. Although the “same” wireless communication service is provided by a satellite telephone and a cellular telephone, the method used to provide such communication service is different. Considering current network infrastructures, 11 it is also more costly to operate the satellite telephone. In certain cases, a POTS communication service may have a cost advantage over particular cellular and/or wireless communications systems. Currently, evolving voice over internet protocol (VoIP) technology is being touted as having a cost advantage over current POTS communication services regarding long distance calls.

Communication services may vary from one another in terms of quality of service. For example, communication service for a hardwired POTS telephone often is clearer than communication service for a cellular or VoIP telephone.

A party that attempts to contact an individual may have one or a limited number of telephone numbers, but not all telephone numbers to contact the individual. For instance, the party may have a cellular telephone number of the individual, but not the individual's POTS telephone number (e.g., the individual does not want everyone to have his home telephone number). And if the individual is at home, it may be more cost effective for the individual to receive calls on the POTS telephone, instead of the cellular telephone.

From the perspective of the calling party, it is frustrating to receive a busy answer or no answer. The receiving individual may have another telephone line available which the calling party may connect to; however, the calling party may not know the telephone number to access the available telephone line. As a result, the calling party is not able to make direct communication with the individual.

### SUMMARY

The systems and methods described herein include identifying the location of a user, locating communication services available to the user, choosing a particular communication service, and routing calls to the chosen communication service.

Locating communication services, in particular may be performed by identification of communication networks by a wireless communication device, where the cellular networks may be particular cellular networks and/or wireless area networks of particular communication services.

Forwarded calls may be sent to the wireless communication device, or alternatively to another communication device.

### BRIEF DESCRIPTION OF THE DRAWINGS

FIG. 1 is a block diagram illustrating an exemplary system that locates a user through a wireless communication device and forwards calls to the user through one of various communication services.

FIG. 2 is a block diagram illustrating an exemplary system that routes calls from various service providers to various carrier networks as instructed by a forwarding system in a wireless communication device.

FIG. 3 is block diagram illustrating an exemplary architecture of a wireless communication device and in particular illustrates an exemplary call forwarding system included in the wireless communication device.

FIG. 4 is a flowchart illustrating a process that locates a user through a wireless communication device, determines communication services available to the user, and provides call forwarding instructions to a chosen communication service.

FIG. 5 is a flowchart illustrating heuristics or conditions set by a user that determine which communication service is chosen and receives forwarded calls.

### DETAILED DESCRIPTION

Example Telecommunications System

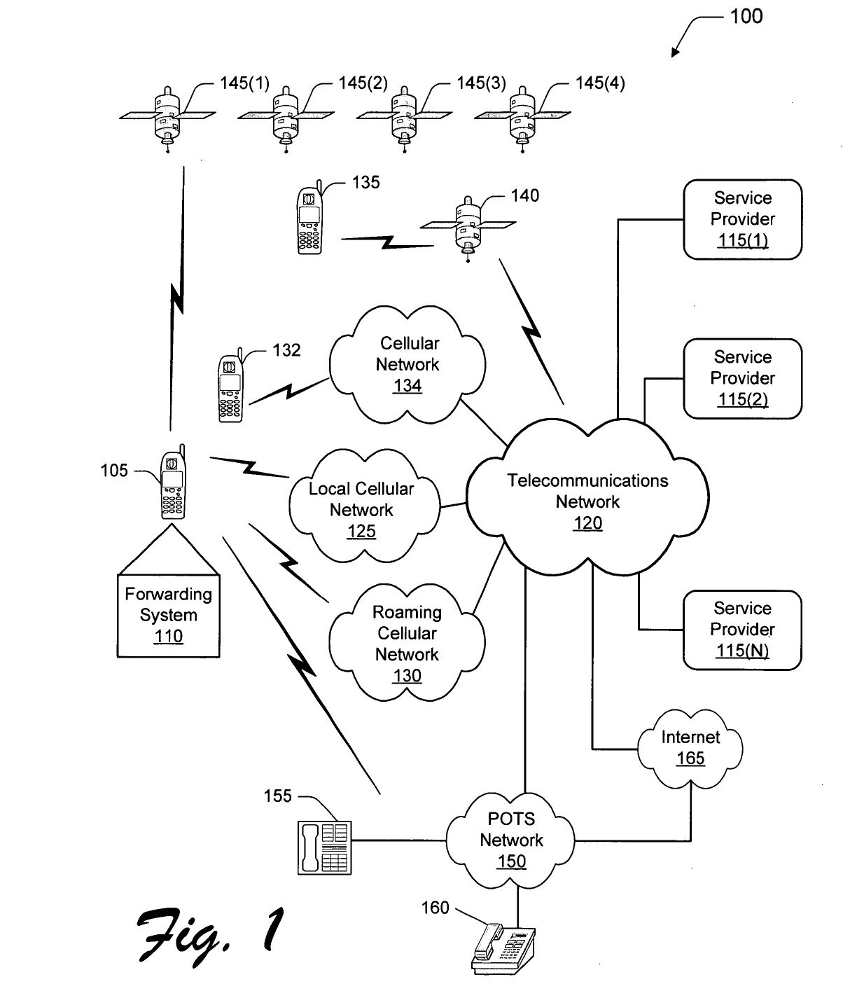

FIG. 1 shows a system 100 that locates a user and forwards calls to the user through a communication service.

A wireless communication device 105, such as a cellular (i.e., wireless) telephone, or a wireless-enabled personal digital assistant (PDA), is carried by a user. It is presumed that wherever the wireless communication device 105 goes, so will the user. Therefore, as the user enters and leaves communication networks, such as cellular networks or wireless local area networks (WLAN) that provide POTS or VoIP telephones, wireless communication device 105 will also enter and leave. Essentially, the user is tracked and located by wireless communication device 105.

As the user and wireless communication device 105 enter a particular communication network, it may be desirable for the user to receive calls from that particular communication network. Wireless communication device 105 includes a forwarding system 110 that instructs service providers 115(1), 115(2), . . . 115(N) to forward calls to a particular communication service supporting the particular communication network. Specifically, calls are forwarded to a carrier network or networks of the particular communication service, as will be discussed below.

The user has communication services that include associated telephone numbers with each of the service providers 115. When forwarding instructions are provided by forwarding system 110 to service providers 115, calls made to telephone numbers of the service providers 115 are routed to the communication service of the desired communication network. Service providers 115 may include cellular telephone service providers, POTS service providers, VoIP service providers, and satellite telephone service providers.

As further discussed below, service providers 115 may include routers to carrier networks that are part of a communication services or part of a telecommunication network 120. Telecommunication network 120 includes various backbone networks, hubs, routers, interchange trunks, wireless/wired lines, and switches. Further, telecommunications network 120 may connect to a number of other networks, including other telecommunication networks and devices.

Telecommunication network 120 may include or be connected to a local cellular network 125 and a roaming cellular network 130. Wireless communication device 105 may be configured to receive and send calls on cellular networks 125 and 130. As the user travels or roams with wireless communication device 105, the user may enter cellular networks 125 and 130. In particular situations, coverage of cellular networks 125 and 130 overlap one another and in certain cases coverage is exclusive to each cellular network.

Wireless communication device 105 is configured to detect cellular networks 125 and 130 through well known methods employing system identification number (SID) and access information that are passed between wireless communication device 105 and cellular networks 125 and 130. Therefore, wireless communication device 105 is configured to determine which cellular network is available. Assuming that calls on local cellular network 125 are “free” calling minutes, it would be ideal to connect with (i.e., receive calls from) cellular network 125 whenever possible, instead of roaming cellular network 130 which may apply significant rates for received calls. Whenever cellular networks 125 and 130 overlap, quality of service being equal (or acceptable to the user), it would be more desirable (i.e., more cost effective) to receive service from local cellular network 125. Forwarding system 110 of wireless device 105 instructs service providers 115 to forward calls to the local cellular network 125.

Other cases may include roaming into a high price service network. Instead of receiving calls when in the high price network, wireless communication device 105 through forwarding system 110, instructs that calls are forwarded to another telephone number or communication service (i.e., carrier network) such as voice mail on a POTS telephone. Once wireless communication device 105 enters or re-enters an acceptable network, calls may be received by wireless communication device 105.

In certain cases, the user may be carrying other wireless communication devices, such as cellular telephone 132, besides wireless communication device 105. Cellular telephone 132 may be communicative to particular communication networks such as cellular network 134 that can not be accessed by wireless communication device 105. For example, wireless communication device 105 may not have a particular personal communication service (PCS) technology used by cellular network 134; however, cellular telephone 132 may be equipped with such PCS technology to communicate with cellular network 134. Or cellular network 134 may not recognize the SID of wireless communication device 105 and is not able to establish a connection. Therefore, when only cellular network 134 is available to the user, it may be desirable to forward calls to cellular telephone 132.

In certain cases, the user may be in a location that provides no access to cellular networks, POTS networks, or any wired/wireless communication network. The only means of communication may be through a satellite telephone 135. Satellite telephone 135 communicates with a low earth orbit satellite 140 which connects through a gateway (typically known in the industry as an “Iridium” gateway) to telecommunications network 120.

If desired by the user, calls may be forwarded by forwarding system 110 to be received by satellite telephone 135. An example scenario of when this takes place is when wireless communication device 105 detects no presence of communication networks, cellular or WLAN. However, since wireless communication device 105 cannot connect to communication network 120 to instruct that calls be forwarded, a prior arrangement may be made with service providers 115 that if wireless communication device 105 cannot be reached (i.e., assumption is made that user and wireless communication device 105 are away from any other communication networks), to forward all calls to satellite telephone 135.

A prior arrangement may also be made that if wireless communication device cannot be reached, to have service providers 115 forward calls to a cellular network such as cellular network 134 which allows the user to communicate on cellular telephone 132. Alternatively, the prior arrangement may be to have calls forwarded to a voice mail of a POTS communication service.

Accurately locating wireless communication device 105, and its location to communication networks (i.e., communication services) available to the user, may be performed through the use of a global positioning satellites (GPS) locator, a map, and a database in wireless communication device 105. The GPS locator receives signals from four GPS satellites 145(1), 145(2), 145(3), and 145(4). Based on distance from the four satellites 145 to the GPS locator of wireless communication device 105, triangulation is performed to locate wireless communication device 105.

The map and database in wireless communication device 105 indicates the locations of communications networks that are accessible by the user. A comparison may be made of the derived location from the GPS locator (i.e., wireless communication device 105) in relation to the communication networks. The comparison relates to proximity of wireless communication device 105 and the user to particular communication networks. If the user is near a particular communication network, it may be desirable to forward calls to that particular communication network. For example, the GPS locator of wireless communication device 105 determines that the user is near a home POTS communication network, and forwarding system 110 sends forwarding instructions to service providers 115 to forward calls to the home POTS communication network.

System 100 may further include plain old telephone systems (POTS) that typically have a hardwire connection (e.g., copper wire or fiber optic wire) to telecommunications network 120. In this example, POTS network 150 is connected to telecommunication network 120. POTS network 150 may represent the user's home communication network or the user's office communication network. Typically POTS network 150 is referred to as a “land line.”

POTS network 150 may include or be connected to a POTS telephone 155 and a VoIP telephone 160. POTS network 150 may further connect to the Internet 165 which connects to telecommunications network 120.

POTS network 150 may be a wireless local area network (WLAN), a wireless personal area network (WPAN), wireless point to point networks, or one of various networks that include wireless and wired connections. POTS network 150 may include a number of wireless protocols such as IEEE 802.11, Bluetooth, and WiFi.

Wireless communication device 105 is enabled with one or more antennas or antenna modules capable of receiving and transmitting various RF frequency signals, and is either able to directly connect to POTS network 150 through one of several access points, or may detect the presence of network 145 through the RF transmission of the access points. The wireless protocols define particular access points that are part of a wireless network. Access points allow devices such as wireless communication device 105 to communicate to the wireless network (e.g. POTS network 150 that includes the wireless network) or to devices that part of the wireless network.

Wireless networks may be distinguished from one another through the use of a service set identifier (SSID) that identifies a particular wireless network to properly configured wireless devices. The SSID is a unique 32-character identifier that is part of a header of packets of information that are sent over a wireless network. A wireless device and a particular access point of a wireless network must have the same SSID to communicate, since SSIDs are used to differentiate one wireless network from another. For example, a wireless network at home may be identified as “MyHomeSSID” and a wireless network at work may be identified as “MyWorkSSID”. Therefore, whenever a wireless device enters a particular wireless network, through the SSID the wireless device “knows” that it is in the particular wireless network.

When wireless communication device 105 attempts to connect to an access point of a wireless network connected to POTS network 150, a SSID is used as a “password” to connect to the wireless network. A SSID may be viewed by the user in a display of the wireless communication device 105.

Wireless communication device 105 may be configured to search for and identify wireless networks through a SSID. The identification of SSIDs and their associated wireless networks, may be used in locating wireless communication device 105 (and the user). For example, when the SSID “MyHomeSSID” is identified by wireless communication device 105, it is assumed that the user is at home, and that calls if so desired may be forwarded by forwarding system 110 to the user's POTS telephone which may be POTS telephone 155.

In certain cases, the use of a SSID as described above may not be needed to merely identify that the wireless communication device 105 has entered a wireless network. In particular, Bluetooth enabled devices are able to communicate with one another without the use of an SSID. Wireless communication device 105 may be configured with Bluetooth hardware and software to communicate with devices (wireless and wired) connected to POTS network 150.

### EXAMPLE ROUTING SYSTEM

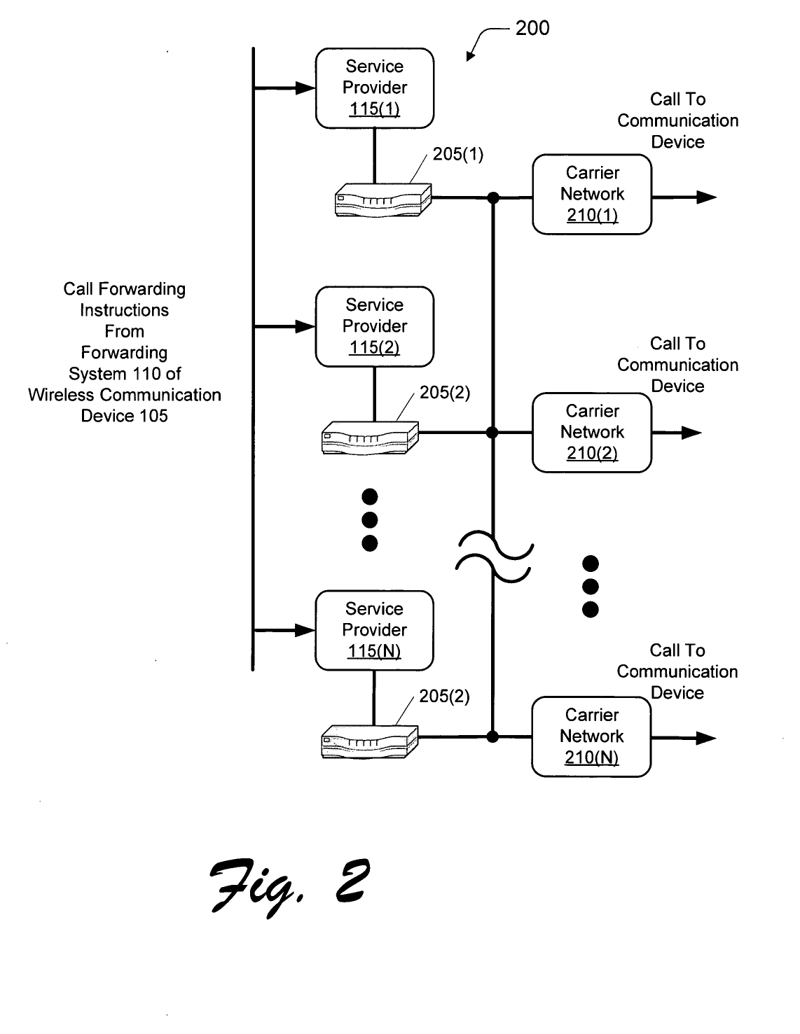

FIG. 2 is a block diagram illustrating an exemplary system 200 that routes calls as instructed by a wireless communication device. The forwarding system 110 of wireless communication device 105 of FIG. 1 provides forwarding instructions to service providers 115 to forward calls destined to the user. In particular, a service provider routes calls to a particular carrier network which sends the calls either to wireless communication device 105 or another communication device such as a land line POTS telephone accessible by the user. Typically, a communication service includes a service provider and a particular carrier network or carrier networks.

As discussed above, service providers 115 receive calls from other parties directed to the user. As instructed by forwarding system 110, service providers 115 forward their received calls for the user to a particular carrier that is associated with a telephone number provided by the forwarding system 110, where the telephone number represents a particular communication system for a communication device. The communication device may be either wireless communication device 105 or some other communication device.

Service providers 115 include or are connected to particular routers 205(1), 205(2), . . . , 205(N). Routers 205 are configured to route calls to one or more carrier networks 210(1), 210(2), . . . , 210(N).

Typically, without call forwarding instructions indicating otherwise, a service provider routes all incoming calls to its particular carrier network or networks, which in turn sends the call to the communication device associated with the service provider.

Call forwarding instructions provide that a service provider route calls to particular carrier networks as instructed by a user, and particularly in this example by forwarding system 110. Unconditional call forwarding instructions provide that all calls received by the service provider are routed to a particular telephone number(s). This is performed by routing the forwarded calls to carrier networks associated with the particular telephone number(s). Conditional call forwarding instructions provide that some calls received by a service provider are routed based on a defined criteria such as “no answer”, “busy”, “caller identification of incoming call”, and “time of day”.

Call forwarding instructions may instruct service providers 115 to forward calls to the same communication device (i.e., same telephone), or may instruct service providers 115 to forward calls to different communication devices (i.e., different telephones).

Carrier networks 210 may be separate from and connect to a network such as a telecommunication network 120 of FIG. 1. In other cases, carrier networks 210 may be part of telecommunication network 120.

As discussed above, a communication service includes a service provider and one or more carrier networks. A particular telephone number is associated with a particular communication service. Therefore, when a party calls a particular telephone number of the user, the call is sent to a service provider associated with the telephone number. Without call forwarding instructions, the call is routed to the carrier network of the service provider.

When call forwarding instructions are provided by forwarding system 110, the service providers 115 reroute received calls to particular carrier networks of particular communication services.

Exemplary Wireless Communication Device

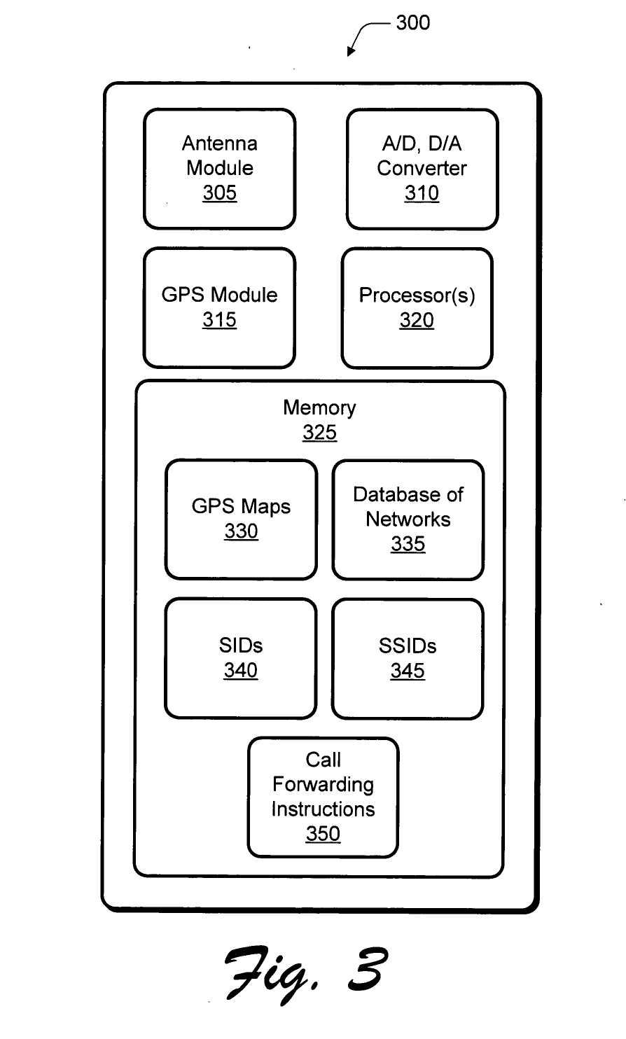

FIG. 3 shows an example architecture 300 of a wireless communication device. Architecture 300 may be implemented on wireless communication device 105 of FIG. 1. In particular, architecture 300 may be implemented as part of wireless communication device 105.

Architecture 300 includes an antenna module 305 that is configured to receive and transmit one or more RF signals at various operating frequencies, in 11 particular RF signals based on cellular or wireless communications. Antenna module 305 may be further configured to receive and transmit RF transmissions based on Bluetooth, IEEE 802.11, WiFi, and/or any one or several other wireless protocols, in particular RF transmissions based on wireless networks. Antenna module 305 may further be configured to receive GPS signals transmitted from GPS satellites.

Architecture 300 includes an analog to digital, digital to analog (A/D, D/A) converter module 310. Converter module 310 is used to convert analog RF signals from antenna module 305 into digital signals that are processed by architecture 300. When transmitting, converter module 310 takes digital signals processed by architecture 300 and converts them to the appropriate analog RF signals to be transmitted. The particular RF signals are dependent on the particular wireless technology that is used for communication. For example, cellular telephone RF transmission frequencies are different than Bluetooth enabled transmission frequencies. Further, a wireless PCS network may have different operating frequencies from an analog cellular network.

Architecture 300 may include a dedicated GPS locator module 315 that is configured to receive GPS satellite information from GPS satellites such as satellites 145 of FIG. 1. GPS locator module 315 is operatively connected to converter module 310 to receive digitally converted satellite signals received by antenna module 305.

Architecture 300 includes one or more processors 320. Processors 320 are configured through hardware, software, or a combination, to handle information received from converter module 310 and coordinate such information and other information with input/output devices that are part of wireless communication device architecture 300 such as a speaker, keyboard (keys), an amplifier, or the like. Processors 320 are further configured to process information stored in memory, devices and modules such as GPS locator module 315 that are part of architecture 300. Processors 320 are particularly configured to detect when RF transmission is received by antenna module 305 that indicates communication networks or wireless networks (e.g., WLAN) that are available to the user.

Architecture 300 further includes a memory 325 which interfaces with processors 315. Processors 315 further communicate with information stored in memory 325 with other modules in architecture 300. Memory 325 includes computer readable media. Although sections of memory 325 may include read only memory, it is contemplated that memory 325 will include writeable sections or volatile memory which may be updated or written to.

Memory 325 includes GPS maps 330 that are used with information received by GPS locator module 315 to indicate location of the wireless communication device which translates to the location of the user. Memory 325 further includes a database of networks 335 that indicates the location of communication networks available to the user. The database 335 may be used with GPS maps, and the information received from GPS locator module 315, to indicate available communication networks that are proximate to the wireless communication device and the user.

Memory 325 may include a section 340 with SID numbers that are associated with cellular networks, and particularly cellular networks accessible by architecture 300. The SID information is used, as described above to distinguish cellular networks from another and connect architecture 300 to particular cellular networks. It is contemplated that section 340 may be updated as the user adds or deletes available wireless communication networks.

Memory 325 may include a section 345 with SSID numbers that are associated with wireless communication networks, and particularly wireless communication networks that provide communication services to the user. In certain embodiments, the information describing SSID numbers in section 345 may be part of database 335. The SSID information is used, as described above, to distinguish wireless communication networks from one another, and to connect the wireless communication device incorporating architecture 300 to particular wireless communication networks. It is contemplated that section 345 may be updated as the user adds or deletes available wireless communication networks.

A section 350 includes call forwarding instructions. Section 350 may be updated to provide particular user defined or chosen heuristics that instruct which communication service(s) to forward calls to, when call forwarding instructions are sent to service providers, and priority of communication services that forwarded calls are sent to. Such call forwarding instructions may include particular conditions such as duration to maintain call forwarding to the particular communication service(s). Alternatively, the call forwarding instructions may be unconditional and changed only when the wireless communication device instructs otherwise.

A user may have a menu set up as a display configured with architecture 300 to choose particular instructions. The menu may be in the form of a graphical user interface, or a list of items to choose from. Further the user through an input/output interface to architecture 300, may enter particular call forwarding instructions.

Exemplary Call Forwarding Process

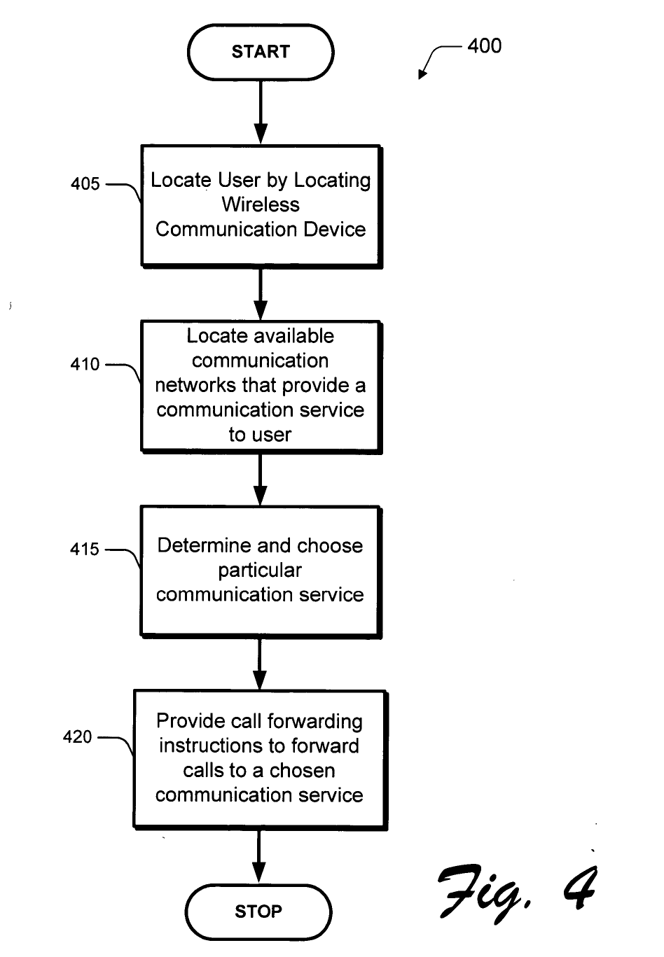

FIG. 4 shows a process 400 that instructs incoming calls directed to a communication device to be forwarded to a communication service that might forward the calls to the same or a different communication device based on user defined heuristics. Process 400 may be implemented on a wireless communication device such as wireless communication device 105 of FIG. 1.

At block 405, a user's location is determined by locating a wireless communication device such as wireless communication device 105. In particular, the wireless communication device's location is determined using methods described above, such as the use of a GPS locator, detecting (i.e., connecting to) cellular or wireless networks, and/or detecting (i.e., connecting to) wireless local area networks that make use of wireless communication protocols using SSID and/or protocols such as Bluetooth.

At block 410, available communication services to the user are determined. In particular, availability of communication networks that provide communication service to the user is determined. The availability of the communication networks to the user is conditioned on the user's location as determined in block 405. For example, if the user is determined to be “near” home, communication service provided for home is available to the user. If the wireless communication device enters a particular cellular network, communication service for that cellular network may be available to the user. In certain cases, the communication service supports the wireless communication device, and in other cases the communication service supports another communication device. In other words, the user may have communication service available through more than one communication device.

At block 415, a determination is made as to whether an available communication service is to be used. The determination is performed based on user defined conditions as described below. In certain cases, it may be desirable to have calls forwarded to a carrier network of an available communication service. Although the user enters a communication network, and communication service is available, there may be no desire or need to change from the present communication service to the newly identified communication service. For example, when the user is operating in a local cellular network then enters a roaming cellular network that overlaps the current local cellular network. As discussed above, for certain cases, a chosen communication service provides calls to a communication device other than the wireless communication device that is used to locate the user.

At block 420, call forwarding instructions are sent to service providers to forward calls to a carrier network or carrier networks of a chosen communication service. Such instructions may be located in and provided by section 350 of FIG. 3.

Different call forwarding instructions allow different permutations for routing telephone calls. Examples of different telephone routing situations include calls be routed to the same telephone using different service providers; calls routed to the same telephone using the same service provider; calls routed to different telephones using different service providers; and calls routed to the different telephones using the same service provider.

### Example User Defined Heuristics to Connect to Communication Service

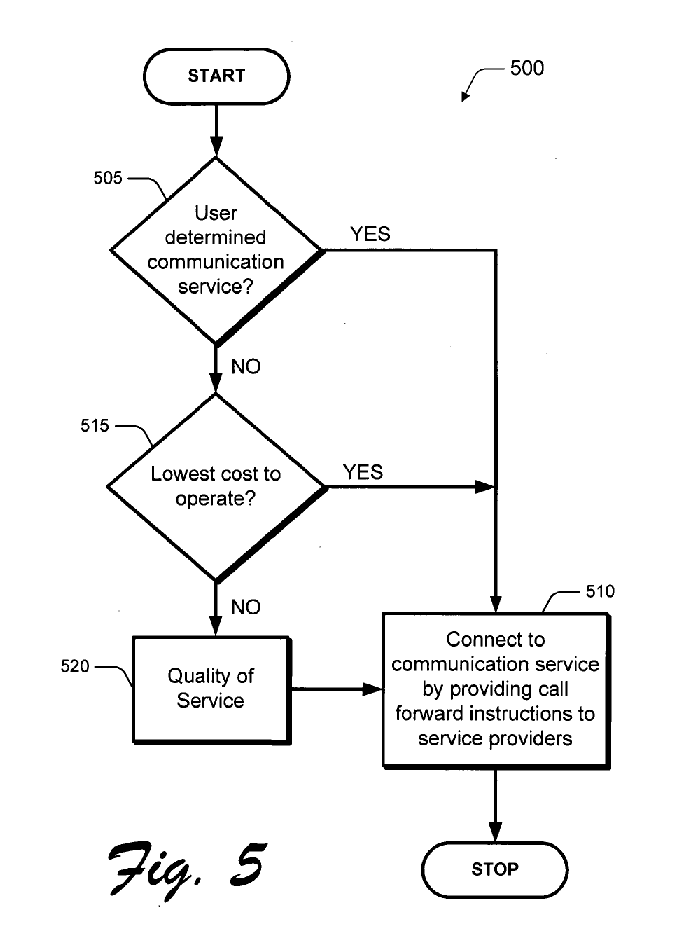

FIG. 5 shows a process 500 that determines which communication service is chosen and receives forwarded calls. Process 500 may be implemented as part of call forwarding instructions resident in section 350 of FIG. 3. It is contemplated that a user chooses, defines, or determines the conditions or heuristics that determine a particular communication service to connect to. The conditions and heuristics illustrated are shown as examples, with numerous conditions and heuristics that may be possible. Such call forwarding instructions may be sent by call forwarding system 110 of wireless communication device 105 of FIG. 1.

At block 505, a determination is made if a user has defined particular conditions to instruct service providers to forward calls to a particular communication service. These particular user defined conditions may include conditions related to time of day (e.g., a user desires to call forward all calls after 5:00 to his home communication service provider and its associated carrier network or networks); and/or location (e.g., a user carrying a wireless communication device such as wireless communication device 105 of FIG. 1 enters an unknown or high cost to operate network instructs that all calls are forwarded to another communication service such as home voice mail).

If a particular user defined condition (heuristic) is found to be true (following the YES branch of block 505), block 510 is performed which provides that call forward instructions are sent to service providers providing communication services to the user to call forward all calls to the particular communication service as determined by the user condition (heuristic) in block 505.

In certain cases, the user may desire to switch to the lowest cost to operate communication network. If no particular user defined heuristics are set or met (following the NO branch of block 505), a determination is made at block 515 if amongst all available communication services there is a lowest cost to operate communication service. An example includes operating within overlapping cellular or wireless networks as discussed above. Everything else being equal, it would be more desirable to operate in a cellular network that provides “free” minutes over another cellular network that is charging roaming rates. Another example may be to use a VoIP telephone over a POTS telephone for long distance calls, if such a choice of communication service is available. If a lowest cost to operate communication service is found (following the YES branch of block 515), block 510 is performed.

If the user does not desire or does not care to connect to the lowest cost to operate communication service (following the NO branch of block 515), it may desirable to the user to connect to a communication service that provides the highest quality of service available. At block 520, the communication service with the highest available quality of service is selected. An example of a communication service that has the highest quality of service can be a land line connected POTS telephone over a cellular telephone with a failing connection signal. When the communication network with the highest quality of service is determined, block 510 is performed.

For other cases, the precedence of blocks 505, 515, and 520 will be in a different order as described. Other cases may provide different heuristics or conditions that will determine the particular communication service to connect to.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A method comprising:
identifying the location of a user;
determining available communication networks that provide communication services to the user;
selecting a particular communication network from the available communication networks; and
sending instructions to service providers providing communication services to the user to forward calls to the particular communication network that is selected.

2. The method of claim 1 wherein the identifying is performed by locating a wireless communication device with the user.

3. The method of claim 2 wherein the wireless communication device is a cellular telephone.

4. The method of claim 2 wherein the wireless communication device is a personal digital assistant.

5. The method of claim 2 wherein the wireless communication device connects to and identifies a cellular network.

6. The method of claim 2 wherein the wireless communication device connects to and identifies a wireless area network.

7. The method of claim 1 wherein the selecting a particular communication network is a plain old telephone system (POTS) communication network.

8. The method of claim 3 wherein the wireless communication device connects to and identifies a wireless area network

9. The method of claim 1 wherein the selecting the particular communication network is based on cost to operate.

10. The method of claim 1 wherein the selecting the particular communication network is based on quality of service.

11. A method comprising:
locating a wireless communication device;
identifying communication services available to the wireless communication device; and
prearranging with service providers to forward calls to a carrier network if communication service is not available to the wireless communication device.

12. The method of claim 11 wherein the prearranging with service providers is to forward calls to a second communication device.

13. The method of claim 11 wherein the prearranging with service providers is to forward calls to a voice mail system of a particular communication service.

14. A method comprising:
connecting a wireless communication device to a wireless area network through an access point;
identifying the wireless area network to the wireless communication device; and
forwarding calls to a communication device on the wireless area network accessible by a user.

15. The method of claim 14 wherein the forwarding calls is to a POTS telephone.

16. The method of claim 14 wherein the forwarding calls is to a voice over Internet (VoIP) telephone.

17. A wireless communication device comprising:
a processor;
an antenna module configured to receive multiple radio frequency (RF) signals;
an analog to digital converter executable on the processor and configured to convert the RF signals to digital signal information used by the processor; and
instructions stored in a memory executable on the processor to store location communication networks available to a user and determine from the digital signal information available communication networks to the user.

18. The wireless communication device of claim 17 wherein the instructions are further comprised to send call forwarding instructions to service providers based on conditions set by the user.

19. The wireless communication device of claim 18 wherein the call forwarding instructions are to forward calls to a particular carrier network.

20. The wireless communication device of claim 18 wherein the conditions are based on lowest cost to operate for a particular communication service.

21. The wireless communication device of claim 18 wherein the conditions are based on quality of service for a particular communication network.

22. The wireless communication device of claim 17 wherein the instructions comprise service set identifier numbers of wireless area networks accessible by the user.

23. The wireless communication device of claim 17 wherein the instructions are further comprised to store service set identifier numbers accessible of wireless area networks accessible by the wireless communication device.

24. The wireless communication device of claim 17 wherein the instructions are further comprised to store system identification number (SID) and access information of cellular networks accessible by the wireless communication device.

25. The wireless communication device of claim 17 further comprising a GPS module configured to receive RF signals from GPS satellites through the antenna module and analog to digital converter indicating location of the wireless communication device.

26. The wireless communication device of claim 25 wherein the instructions are further comprised of map that indicates to a user relative location of the wireless communication device.

27. A processor in a wireless communication device comprising:
means for receiving information describing an RF signal from an antenna module which receives the RF signal from a communication network;
means for determining location of the wireless communication device in relation to the communication network;
means for transmitting instructions from the antenna module for service providers to forward calls to a particular carrier network.

28. A processor in a wireless communication device comprising:
means for receiving information describing an RF signal from an antenna module which receives GPS signals;
means for locating the wireless communication device and communication networks available to a user through the information; and
means for transmitting instructions from the antenna module for service providers to forward calls to a particular carrier network.

29. A computer-readable medium comprising computer-executable instructions for sending call forward instructions, the computer-executable instructions comprising instructions for:
locating a wireless communication device;
finding communication networks available to a user of the wireless communication device;
determining whether to forward calls to a carrier network supporting a particular communication network;
sending call forwarding instructions to all service providers of the user to the carrier network if so determined.

30. The computer-readable medium of claim 29 wherein the locating is performed by a GPS locator of the wireless communication device.

31. The computer-readable medium of claim 29 wherein the locating is performed by communicating by the wireless communication device to an access point on a wireless area network.

32. The computer-readable medium of claim 29 wherein the finding is performed by assessing a database of the wireless communication device and comparing the determined location of the wireless communication device.

33. The computer-readable medium of claim 29 wherein the determining is performed based on lowest cost to operate communication service.

34. The computer-readable medium of claim 29 wherein the determining is performed based on quality of service of communication service.

35. A system comprising:
a wireless communication device to locate its user relative to one or more communication networks accessible by the user;
one or more service providers which receive instructions by the wireless communication device to forward received calls to a carrier network; and
a telecommunication network to send the forwarded calls to a Communication device of the user.

36. A system comprising:
a wireless communication device;
one or more access points on a wireless area network, wherein the wireless communication device communicates with the wireless area network through an access point; and
a communication device on the wireless area network that receives forwarded calls as instructed by the wireless communication device.
